(19) United States
(12) Patent Application Publication
(10) Pub. No.: US 2020/0047393 A1
(43) Pub. Date: Feb. 13, 2020

(54) BLOW MOLDING MACHINE SUITABLE FOR MANUFACTURING A BOTTLE HAVING A HANDLE AND METHOD FOR USING THE SAME

(71) Applicant: CHUMPOWER MACHINERY CORP., Taichung City (TW)

(72) Inventors: WEN-YUNG YANG, TAICHUNG CITY (TW); SHU-LIN HSIEH, TAICHUNG CITY (TW); HUAI-RONG PAN, TAICHUNG CITY (TW); ZHI-ZHONG LUO, TAICHUNG CITY (TW); PO-CHENG LAI, TAICHUNG CITY (TW)

(21) Appl. No.: 16/101,513

(22) Filed: Aug. 12, 2018

(51) Int. Cl. B29C 49/06; B29C 49/48; B29C 49/64

(52) U.S. Cl. CPC B29C 49/062; B29C 49/421; B29C 49/6427; B29C 49/482

(57) ABSTRACT

A blow molding machine suitable for manufacturing the bottle having the handle and a method for using the same, wherein each of the preform holders has a local temperature regulating device, the local temperature regulating devices are disposed around the handle portion, the rotary joint supplies liquid or gas continuously to the local temperature regulating devices of the preform holders to perform continuous temperature regulation for the handle portion, thereby overcoming the problem that the temperature needs to be immediately cooled after the injection molding, and temperature of the body portion can be maintained, so as to achieve the purpose of reducing energy consumption.

### BACKGROUND

### Field of the Invention

The present invention relates to a blow molding machine suitable for manufacturing a bottle having a handle and a method for using the same.

### Related Prior Art

The working process of a conventional blow molding machine suitable for manufacturing bottles is generally to make a preform by injection molding, and then subject the preform to blow molding to obtain a finished bottle. However, the relationship between the ejection molding mechanism and the bottle blowing mechanism of different types of blow molding machines is very different.

The blow molding machine can be roughly divided into one-stage blow molding and two-stage blow molding. The difference is that the injection molding mechanism of the two-stage blow molding is usually at a certain distance from the blowing mechanism. Therefore, after the preform is injected molded by the injection mechanism, a conveyor belt needs to be used to move the preform to the blowing mechanism. With this two-stage molding, the preform must be reheated after cooling down and then can be blow molded, therefore, the two-stage molding is also known as the “cold preform molding” in the industry. However, before being moved to the blowing mechanism, the preform cannot be directly processed by the blowing mechanism due to the fact that the orientation of the preform has been changed. For this reason, it is necessary to use a preform positioning/orientation mechanism to pre-position the preform, then the preform can be blow molded. As a result, the manufacturing process is complicated, there are numerous mechanisms on the manufacturing line, and energy consumption is large.

In addition, one-stage molding, also known as direct blow molding, is to first injection mold a preform in the molten state on the same injection blow molding machine, and then stretch and blow mold the molten preform in a hollow mold. With this one-stage molding, the preform is stretched and blow molded when it is not cooled, namely, by the blow molding is performed by taking advantage of the heat retained by the molten preform, and therefore, it can also be called as hot preform molding.

However, one-stage molding is only applicable to the molding of the bottle of general type, namely, the bottle having uniform thickness and without a handle. If it is necessary to produce a bottle with a handle or a bottle of non-uniform thickness, a rather complicated manufacturing process is required, as described below, with reference to FIG. 1:

A machine 70 has a turntable 71, a motor 72 and a plurality of worktables 73. The motor 72 is drivingly connected to the turntable 71 to drive the turntable 71 to rotate. Each of the worktables 73 is disposed on the turntable 71. In addition, an injection station 741, a temperature regulating station 742, a blowing station 743 and a take-out station 744 are cooperated with each of the worktables 73. Since the handle of the bottle body with a handle does not need to be subjected to a blow molding process, the preform must be cooled to a stable state before the blow molding operation, and then it can be moved to the blowing station 743. However, the thickness of the handle is normally thicker than the thickness of the bottle. Therefore, when the handle of the preform is cooled to a lower temperature, the bottle body of the preform has already been cooled down to a state in which it cannot be directly blow molded. For this reason, the temperature regulating station 742 must be set between the injection station 741 and the blowing station 743 to heat the preform to a temperature at which the blow molding can be performed, which, however, will lead to the problems of cumbersome operation procedure and excessive energy consumption.

In order to solve the aforementioned problems, there is a need for a blow molding machine suitable for manufacturing a bottle having a handle and a method for using the same, which is low in energy consumption and simple in mechanism.

### SUMMARY

The present invention provides a blow molding machine suitable for manufacturing a bottle having a handle, the main objective of which is to reduce energy consumption.

Another objective of the invention is to simplify the mechanism and reduce costs.

The present invention further provides a method of using the aforementioned blow molding machine suitable for manufacturing a bottle body having a handle, the main objective of which is to reduce energy consumption.

Another objective of the invention is to simplify the mechanism and reduce costs.

To achieve the above objectives, a blow molding machine suitable for manufacturing a bottle having a handle, the bottle having a handle is made from a bottle preform having a handle portion, the bottle preform includes a body portion connected to the handle portion, the body portion has a bottle thickness, the handle portion has a handle thickness which is greater than the bottle thickness, and the blow molding machine suitable for manufacturing the bottle having the handle comprises:
a machine, an injection device, a blowing device and a rotary joint, wherein the injection device and the blowing device are disposed around the machine;
the machine includes a turntable, the turntable has a plurality of worktables, each of the worktables includes at least one preform holder, each of the preform holders is provided for holding the bottle preform injection molded by the injection device, and each of the preform holders has a local temperature regulating device;
the rotary joint is disposed on the turntable and in communication with each of the preform holders of the worktables, the rotary joint is provided for supplying liquid or gas to each of the local temperature regulating devices, and the local temperature regulating devices are disposed around the handle portion;
by such arrangements, the rotary joint continuously supplies the fluid to the local temperature regulating devices to perform continuous temperature regulation for the handle portion, the blowing device is disposed around the handle portion, then the body portion is injected with gas to blow the bottle perform into the bottle having the handle.

A method for using the blow molding machine suitable for manufacturing the bottle having the handle, comprises:
an injection molding step including injection molding the bottle preform between the preform mold and the corresponding one of the worktables by using the injection body, wherein the bottle preform has the body portion and the handle portion, and a thickness of the handle portion is larger than a thickness of the body portion, then, wrapping the local temperature regulating devices around the handle portion;
a local cooling step including using the rotary joint to supply liquid or gas continuously to the local temperature regulating devices of the preform holders to perform continuous temperature regulation for the handle portion; and
a local blow molding step including closing the first mold and the second mold, making the body portion of the bottle preform located between the first mold and the second mold, and blowing the bottle preform into the bottle having the handle by injecting high pressure gas into the body portion.

As described above, each of the preform holders has a local temperature regulating device, the local temperature regulating devices are disposed around the handle portion, the rotary joint supplies liquid or gas continuously to the local temperature regulating devices of the preform holders to perform continuous temperature regulation for the handle portion, thereby overcoming the problem that the temperature needs to be immediately cooled after the injection molding, and temperature of the body portion can be maintained, so as to achieve the purpose of reducing energy consumption.

Furthermore, the present invention adopts a one-stage molding, so that the bottle perform can be directly processed with local blowing molding process without being rotated, thereby effectively simplifying the manufacturing mechanism and reducing the cost.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is an illustrative view of a conventional blow molding machine;

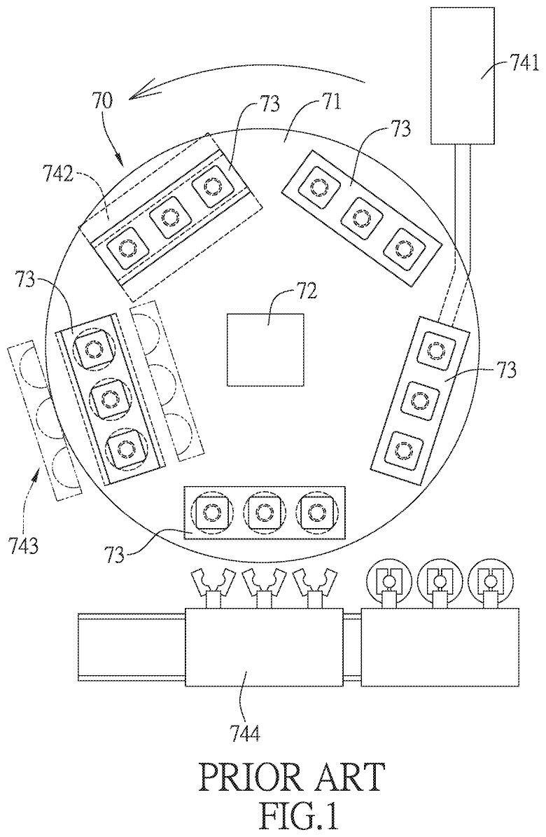

FIG. 2 is an illustrative view of the blow molding machine suitable for manufacturing a bottle having a handle in accordance with the present invention;

FIG. 3 is a perspective view of a bottle having a handle made by the blow molding machine of the invention;

FIG. 4 is a cross sectional view of the bottle having a handle made by the blow molding machine of the invention; and

FIG. 5 is a flow chart view of the method for using the blow molding machine suitable for manufacturing a bottle having a handle in accordance with the invention.

### DETAILED DESCRIPTION

The present invention will be clearer from the following description when viewed together with the accompanying drawings, which show, for purpose of illustrations only, the preferred embodiment in accordance with the present invention.

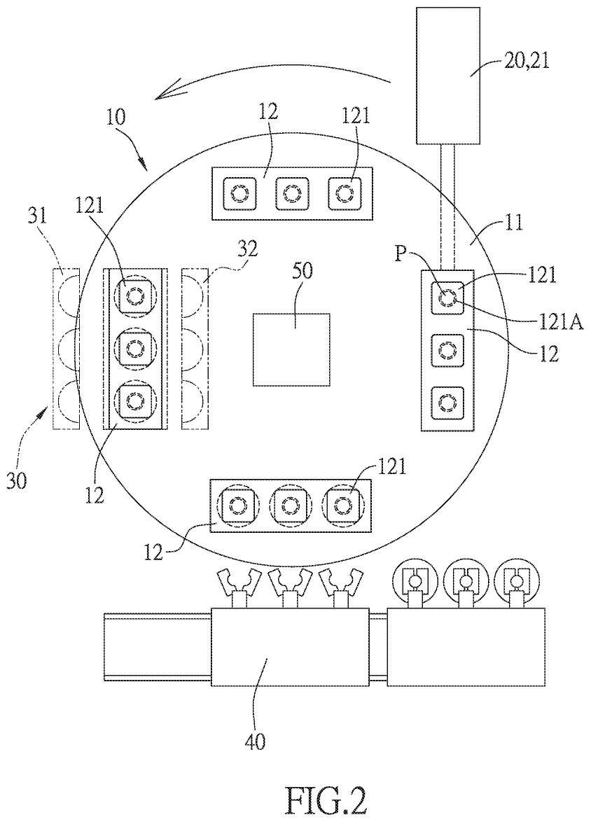

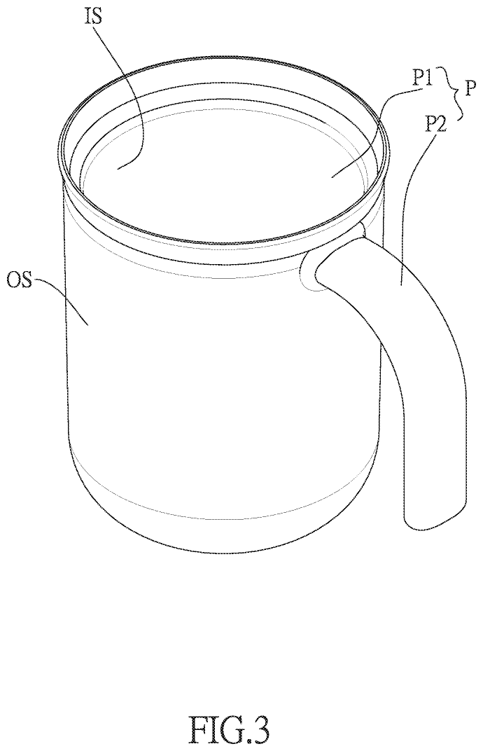

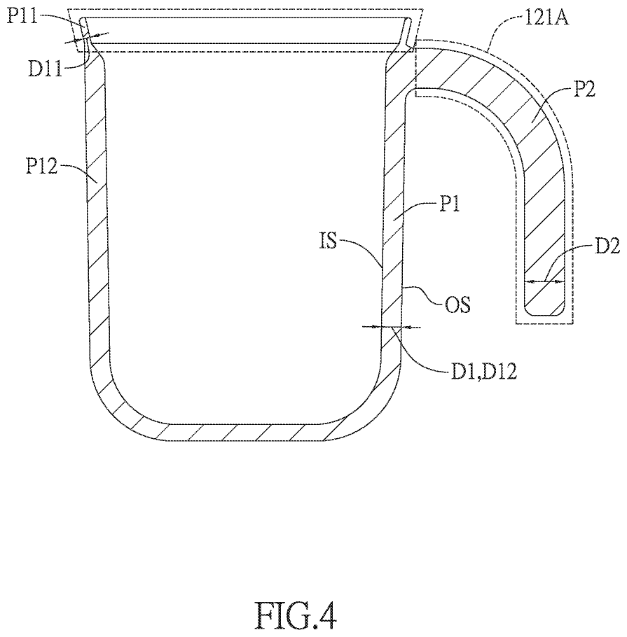

Referring to FIGS. 2-4, a blow molding machine suitable for manufacturing a bottle having a handle in accordance with the present invention comprises: a machine 10, an injection device 20, a blowing device 30 and a rotary joint 50, wherein the injection device 20 and the blowing device 30 are disposed around the machine 10.

The machine 10 includes a turntable 11 having a plurality of worktables 12, each of which is equiangularly disposed on the turntable 11, and each of the worktables 12 includes at least one preform holder 121. Each of the preform holders 121 is provided for holding a bottle preform P, and each of the preform holders 121 has a local temperature regulating device 121A.

The rotary joint 50 is disposed on and rotates along with the turntable 11, and is in communication with each of the preform holders 121 of the worktables 12. Preferably, the rotary joint 50 is in communication with the local temperature regulating device 121A. The rotary joint 50 is provided for supplying liquid or gas to each of the local temperature regulating devices 121A to perform continuous temperature regulation for the handle portion P2. In an embodiment, the liquid is cooling water.

The injection device 20 has an injection body 21 and a preform mold (not shown). The preform mold is disposed under the turntable 11, and the preform mold is aligned with one of the worktables 12. The injection body 21 is connected to the preform mold, and cooperates with the corresponding worktable 12 to form the bottle preform P on each of the preform holders 121. The method of injection molding the bottle preform P is prior art, the details of which are not explained in detail.

The bottle preform P includes: a body portion P1 and a handle portion P2 connected to the body portion P1, and the body portion P1 has an inner surface IS and an outer surface OS. The inner surface IS extends to the outer surface OS by an extension length which is a bottle thickness D1. The handle portion P2 is solid, and has a handle thickness D2 which is defined as an extension length between two opposite sides of the handle portion P2. The handle thickness D2 is greater than the bottle thickness D1, and the local temperature regulating devices 121A of each of the preform holders 121 are disposed around each of the handle portions P2 to perform continuous temperature regulation for the handle portion P2.

The blowing device 30 is disposed below the turntable 11, aligned with a corresponding one of the worktables 12, and has a first mold 31 and a second mold 32 which are movable relative to each other. The number of the mold holes of the first mold 31 and that of the second mold 32 correspond to the number of the preform holders 121. The first mold 31 and the second mold 32 are disposed around the body portion P.

In a preferred embodiment, the present invention further includes a gripping device 40 disposed around the machine 10 to grab the bottle having a handle formed by the blow molding process.

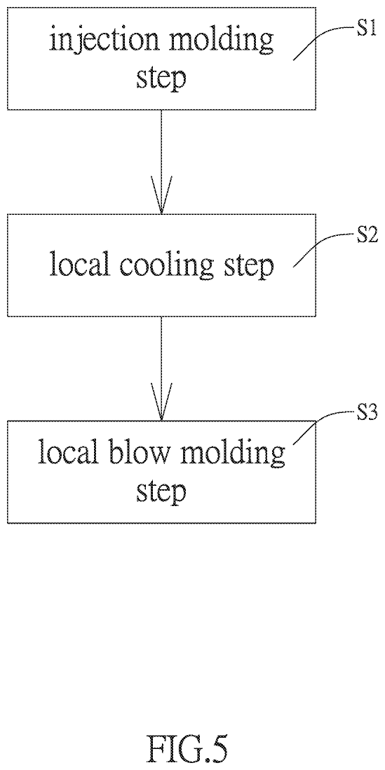

The present invention further provides a method for using the blow molding machine suitable for manufacturing a bottle having a handle, as shown in FIG. 5, comprising:
an injection molding step S1 including injection molding the bottle preform P between the preform mold and a corresponding one of the worktables 12 by using the injection body 21, wherein the bottle preform P has the body portion P1 and the handle portion P2, and a thickness of the handle portion P2 is larger than a thickness of the body portion P1, then, wrapping the local temperature regulating devices 121A around the handle portion P2;
a local cooling step S2 including using the rotary joint to supply liquid or gas continuously to the local temperature regulating devices 121A of each of the preform holders 121 to perform continuous temperature regulation for the handle portion P2; and
a local blow molding step S3 including closing the first mold 31 and the second mold 32, so that the body portion P1 of the bottle preform P is located between the first mold 31 and the second mold 32, then, blowing the bottle preform P into a bottle having the handle by injecting high pressure gas into the body portion P1.

While we have shown and described various embodiments in accordance with the present invention, it is clear to those skilled in the art that further embodiments may be made without departing from the scope of the present invention.

What is claimed is:

1. A blow molding machine suitable for manufacturing a bottle having a handle, being applicable to a bottle preform having a handle portion, and the blow molding machine suitable for manufacturing the bottle having the handle comprising:
a machine, an injection device, a blowing device and a rotary joint, wherein the injection device and the blowing device are disposed around the machine;
the machine includes a turntable, and the rotary joint rotates along with the turntable and serves to supply fluid to cool the handle portion.

2. The blow molding machine suitable for manufacturing the bottle having the handle as claimed in claim 1, wherein the turntable has a plurality of worktables, each of the worktables includes at least one preform holder, each of the preform holders is provided for holding the bottle preform injection molded by the injection device, and the rotary joint serves to supply the fluid to the preform holders.

3. The blow molding machine suitable for manufacturing the bottle having the handle as claimed in claim 2, wherein the rotary joint is disposed on the turntable and in communication with each of the preform holders of the worktables.

4. The blow molding machine suitable for manufacturing the bottle having the handle as claimed in claim 1, wherein the fluid is liquid or gas.

5. The blow molding machine suitable for manufacturing the bottle having the handle as claimed in claim 2, wherein the bottle preform is processed into the bottle having the handle, and includes a body portion connected to the handle portion, each of the preform holders has a local temperature regulating device, the rotary joint is provided for supplying liquid or gas to each of the local temperature regulating devices, and the local temperature regulating devices are disposed around the handle portion;
by such arrangements, the rotary joint continuously supplies the fluid to the local temperature regulating devices to perform continuous temperature regulation for the handle portion, the blowing device is disposed around the handle portion, then the body portion is injected with gas to blow the bottle perform into the bottle having the handle.

6. The blow molding machine suitable for manufacturing the bottle having the handle as claimed in claim 5, wherein the injection device has an injection body and a preform mold, the preform mold is disposed under the turntable, the preform mold is aligned with a corresponding one of the worktables, the injection body is connected to the preform mold and cooperates with the corresponding one of the worktables to form the bottle preform on each of the preform holders;
the blowing device is disposed below the turntable, aligned with another corresponding one of the worktables, and has a first mold and a second mold which are movable relative to each other and disposed around the body portion.

7. The blow molding machine suitable for manufacturing the bottle having the handle as claimed in claim 5, wherein the body portion has a bottle thickness, and the handle portion has a handle thickness which is greater than the bottle thickness.

8. The blow molding machine suitable for manufacturing the bottle having the handle as claimed in claim 7, wherein the body portion has an inner surface and an outer surface, the inner surface extends to the outer surface by an extension length which is the bottle thickness, and the handle thickness is defined as an extension length between two opposite sides of the handle portion.

9. The blow molding machine suitable for manufacturing the bottle having the handle as claimed in claim 5, wherein the rotary joint is in communication with the local temperature regulating device.

10. A method for using the blow molding machine suitable for manufacturing the bottle having the handle as claimed in claim 6, comprising:
an injection molding step including injection molding the bottle preform between the preform mold and the corresponding one of the worktables by using the injection body, wherein the bottle preform has the body portion and the handle portion, and a thickness of the handle portion is larger than a thickness of the body portion, then, wrapping the local temperature regulating devices around the handle portion;
a local cooling step including using the rotary joint to supply liquid or gas continuously to the local temperature regulating devices of the preform holders to perform continuous temperature regulation for the handle portion; and
a local blow molding step including closing the first mold and the second mold, making the body portion of the bottle preform located between the first mold and the second mold, and blowing the bottle preform into the bottle having the handle by injecting high pressure gas into the body portion.
